(19) United States
(12) Patent Application Publication
(10) Pub. No.: US 2009/0042603 A1
(43) Pub. Date: Feb. 12, 2009

(54) WIRELESS NETWORK ACCESS MULTI-MEDIA APPARATUS

(75) Inventors: TUNG NING, TAICHUNG CITY (TW); NICHOLAS FOTHERGILL-ZITTRER, TAICHUNG CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: HUVEUR TECHNOLOGIES INC., TAICHUNG CITY (TW)

(21) Appl. No.: 11/836,417

(22) Filed: Aug. 9, 2007

(51) Int. Cl. H04M 1/00

(52) U.S. Cl. 455/556.1

(57) ABSTRACT

This invention discloses a wireless network access multi-media apparatus having a central processing unit and a hardware driver in conformity with a connector. The connector is a wireless network connector or a cable network connector, and the host pre-stores an identity code database, so that the wireless network access multi-media apparatus can be connected to a network and a remote storage equipment through an intermediary server at the network storage end. The connection is a connection to a storage device controlled by a server or simply a connection to a storage device, so that the host can access the data in the storage device at the storage end after authentication and the host becomes a multi-media entertainment player or a work tool at a portable mobile end without requiring additional download and setup or a storage device, and thus the invention provides a quick, convenient and low-cost application.

### FIELD OF THE INVENTION

The present invention relates to a wireless network access multi-media apparatus, and more particularly to a hot spot of a wireless network connected to a remote storage device on the network through an intermediary server for accessing the remote storage device on the network by a predetermined method to achieve the effects of high security, convenience and practicability.

### BACKGROUND OF THE INVENTION

At present, service providers provide lots of spaces on a network for consumers to log on a network or post their data or photos and even life records or movies on the network or save data in a memory space, so that when a user wants to use these data, the user needs to connect to a network through a computer and go through an authentication to download the data, and then after the computer loads the data on the network, the data is displayed on the computer. However, the aforementioned method cannot be used in an environment without a computer, and thus the method cannot satisfy the user requirement of accessing data anytime.

In addition, present portable products such as 3G mobile phones are connected via a telecommunication network, but the use of storage spaces on a website is still limited to the access mode of a general network connection. Even after a user logs on a network with a user ID, the hardware structure and method for the application of accessing data through a specific website over a network or performing an active push by a telecommunication network company to push related messages to the user's mobile phone or portable product still have the drawbacks as listed below:

1. The cost is high. The hardware at a portable mobile end and a computer incur a relatively high cost, plus the application is inconvenient, and thus the prior art requires improvements.

2. The use of messages is limited by the hardware equipment. Since the hardware at the portable mobile end incurs a high cost, the design and dimensions of its display panel are limited, and the display and recognition level of data accessed from the network are poor, and thus the prior art requires improvements.

3. The operation of accessing data on a network is inconvenient. The connection at a portable mobile end not only requires a whole set of equipments, but also has to go through a complicated procedure, and thus the prior art is inconvenient.

Referring to FIG. 5 for a display device, the structure of the display device comprises a host 90, a central processing unit 91 installed in the host 90 and connected to a data storage device, a power connection portion 93, an I/O port 94 and a screen 95 driven by a driver; and the data storage device 92 is generally a hard disk, and the I/O port 94 comprises a card reader 940 and at least one set of message I/O port 941. Most of the time, such structure is operated at offline, and the data is pre-stored in the data storage device 92 or stored in a memory card, and then the card reader 940 reads the data decoded by the central processing unit 91, and the screen 95 outputs and displays the contents of the data, but such structure still has the following shortcomings:

1. The structure has limited applications. The structure is generally used at offline, so that the data must be pre-stored in the data storage device 92 or a card for the expected result, and thus the overall structure cannot download or update data immediately, and its application is limited. Most of the time, the structure is used for a specific application such as a fixed billboard or a fixed display structure for displaying data, and the structure of this sort is difficult for a general user to use.

2. The overall cost is still high. The overall hardware architecture requires a data storage device 92 with lots of empty memory spaces in addition to the installation of a display device and a central processing unit, and thus the cost is very high. Even for a small computer system, such simple playback application cannot afford a high cost.

### SUMMARY OF THE INVENTION

Therefore, it is a primary objective of the present invention to provide a wireless network access multi-media apparatus, wherein the data on a website or a network is pre-stored in a storage device at a storage end, and a host at a portable mobile end includes an identity code database and an I/O connector having a wireless network connector for connecting the network with the storage device at the storage, in addition to a central processing unit and a related hardware driver. With a user database stored in an intermediary server at a location before a host end or the storage end, the host at the portable mobile end can carry out the operations of the storage device directly via a hot spot on the network, so as to enhance the operability and performance of accessing data in the device.

### BRIEF DESCRIPTION OF THE DRAWINGS

FIG. 1 is a schematic view of the hardware architecture of a host at a portable mobile end in accordance with a first preferred embodiment of the present invention;

FIG. 2 is a schematic view of the hardware architecture of a host at a portable mobile end in accordance with a second preferred embodiment of the present invention;

FIG. 3 is a schematic view of a portable mobile end and a storage end operating with a network in accordance with the present invention;

FIG. 4 is a schematic view of a driving method of the present invention; and

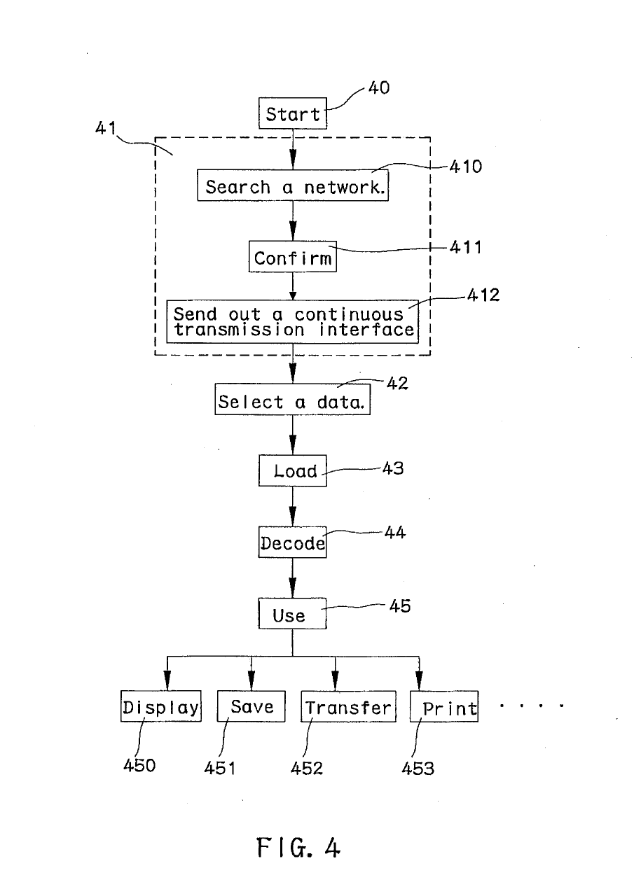

FIG. 5 is a schematic view of a prior art data accessing device.

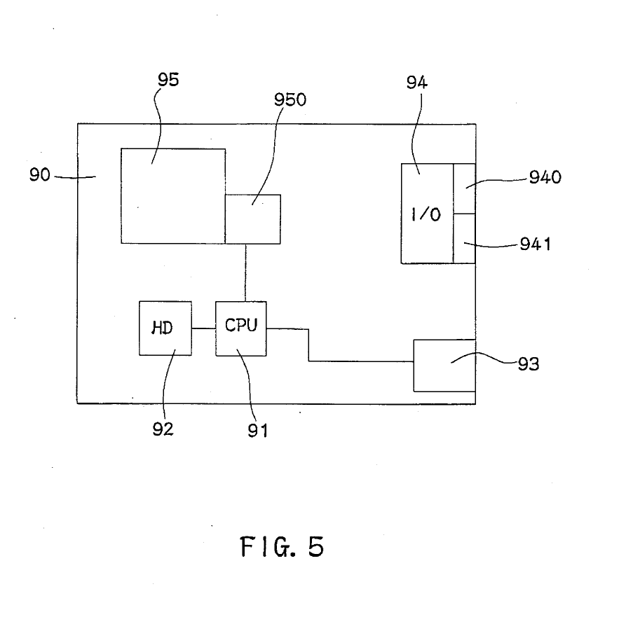

### DETAILED DESCRIPTION OF THE PREFERRED EMBODIMENTS

To make it easier for our examiner to understand the technical characteristics of the invention, we use preferred embodiments together with the attached drawings for the detailed description of the invention, but the preferred embodiments are used for illustration only and not intended to limit the scope of the invention.

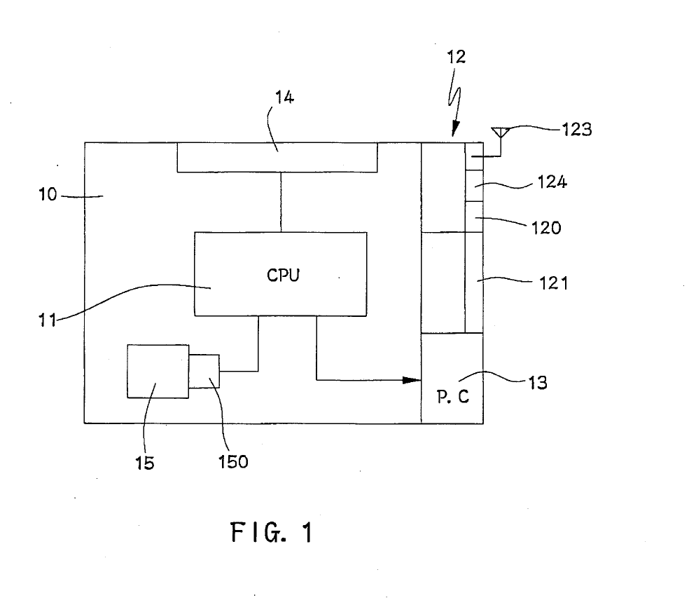

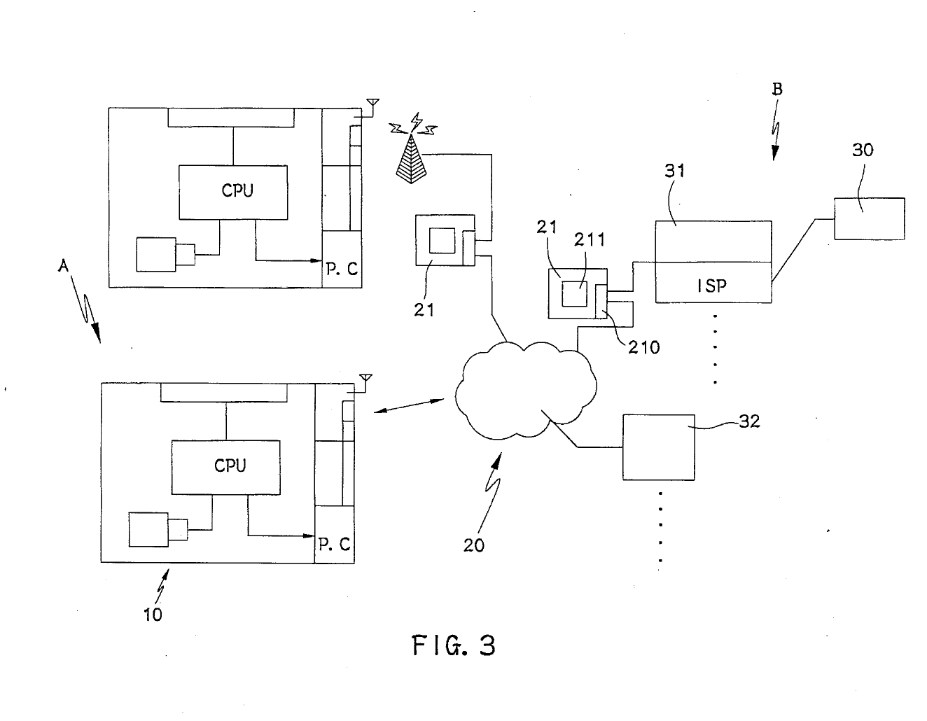

Referring to FIGS. 1 to 3, the architecture of the present invention can be divided into a portable mobile end A and a storage end B in conformity with a network, wherein the portable mobile end A is mainly a hardware structure having a host 10, and the host 10 includes a central processing unit 11 disposed therein and connected to an I/O port 12 and a power connection portion 13 respectively, an identity code database 14 in conformity with the central processing unit 11. The host 10 further includes an output device 15 and its hardware driver 150 depending on a user's requirement; wherein the I/O port 12 includes a card reader 120 and a message I/O port 121 as well as a wireless network connector 123 and a cable network connector 124 for externally connecting a network 20, and another end of the network 20 is a storage end B. The present invention is characterized in that an intermediary server 21 is installed on the network 20 between the portable mobile end A and the storage end B or at a position proximate to either end A, B for paring the corresponding storage end B and portable mobile end A for transmitting data directly.

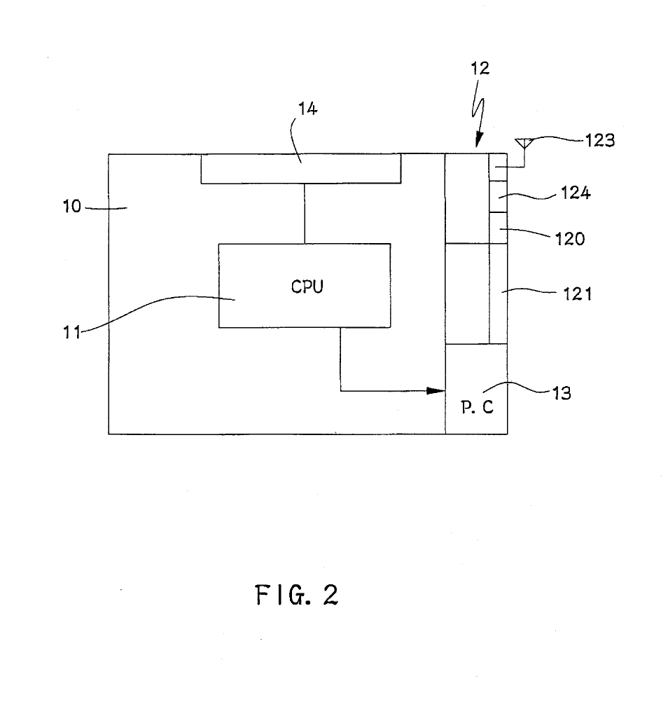

The output device 15 can be a display device assembly directly installed at the host 10 as shown in FIG. 1. The host 10 may not install related output device 15 and hardware driver 150 as shown in FIG. 2, but the host 10 still can access data at the storage end B through the network immediately.

The wireless network connector 123 is a telecommunication transceiver of a wireless Internet 20 or a transceiver of a phone network 20.

The cable network connector 124 is a telecommunication transceiver concurrently for the Internet 20 and the telecommunication network 20.

The identity code database 14 contains a device identity code, and the identity code is registered to the intermediary server 21 which is a small gateway controller, a network router or a data printing device for connecting the network 20 externally.

The intermediary server 21 further includes a user database 211 integrated with the host 10 or installed at a position of the storage end B, in addition to the externally connected I/O port 210, and whose data are printed files of a user related data, a data of a corresponding storage device 30 of a server 31 at a storage end B; the user database 210 contains related identity data of one or more users, a data address, a name, an identity code, a password or a channelization code of a corresponding website, ISP, network gateway, server or hard disk set up by the users for immediately connecting and authenticating the storage end B during a connection to the network.

The external connecting architecture of the invention is connected with the network 20 by a wireless network connector 123 and a cable network connector 124, and another end of the network 20 is the storage end B, and the storage end B can be a storage device 30 or a storage device 30 controlled by a server 31.

The network 20 is a telecommunication network or the Internet.

The server 31 is a general network server 31 of a website service provider, a corporation or an individual.

The storage device 30 of the server 31 is a database controlled by the server 31 or not controlled by the server 31 or stored in a storage space, a Blog, a network album, a network and a personal multi-media database stored in a hard disk, a storage space, an optical disk or the Internet.

The driving method of the invention comprises the following steps:

Start 40: A user presses a power switch directly on the host 10 to turn on the host 10;

Connect 41: The connection includes the steps as listed below:

Search a network 410: The central processing unit 11 of the host 10 is connected to a hot spot of the network 20 through the wireless network connector 123 of the I/O port 12 for sending related website data and each storage address of the corresponding related user database 14 to the network 20 at the storage end B for performing the search operation.

Confirm 411: If the server 31 at the storage end B matching the condition of sending data of the user database 14 is confirmed to be corresponsive to the storage device 30, then the portable mobile end A and the storage end B will be connected;

Transmit a continuous transmission interface 412: After confirmation, the user database 14 of the server 31, the storage device 30 or the host 10 sends a continuous transmission interface to the host 10;

Select a data 42: A user can enter into a continuous transmission interface for selecting the operation of accessing data;

Load 43: The data is loaded into the central processing unit 11 after the selection;

Decode 44: The central processing unit 11 decodes the data and converts the data into a usable message;

Use 45: The central processing unit 11 sends the decoded message to the I/O port 12 for the use by an externally connected device, or the duplication of data by the card reader 120, or the display of corresponding data by the output device 15 driven by the hardware driver 150, and a variety of applications can be achieved and they are divided as follows:

Display 450: Display data on a display device;

Storage 451: Send data to a card reader 120 for its storage operation;

Transfer 452: Transfer data from an I/O port 12 to a user at another location;

Print 453: Print data from the I/O port 12.

With the aforementioned hardware architecture, network communication and application, the present invention can achieve the following functions and effects:

1. The hardware cost is low, since the portable mobile end A has no storage structure. Furthermore, the connection is automatic, and thus it is not necessary to connect with additional operating hardware or perform additional operations, and the cost of hardware at the portable mobile end A can be minimized.

2. The architecture at the storage end B remains unchanged. With the mechanism of connecting the host 10 automatically and decoding data immediately, the hardware or software architecture at the storage end B can remain unchanged, and thus the overall cost can be lowered.

3. The application is fast and convenient, since the host 10 automatically connects a corresponding structure at a storage end B through a network 20, and users need not to perform the connection additionally. The application is faster and more convenient than the operation of a computer, and thus this application is used extensively, particularly by those who do not know how to use a computer to connect to a network very well, and users at a beginner level can use the host 10 at the portable mobile end A to connect to different storage spaces or devices at the storage end B easily.

What is claimed is:

1. A wireless network access multi-media apparatus, comprising a portable mobile end, an intermediary server and a network storage device, wherein, the portable mobile end, having a host, a central processing unit installed in the host and connected to an I/O port, a power connection portion having an identity code, and a network connecting device;
the intermediary server, having a user database, and connected to a remote server or a storage equipment according to a setup of the user database, for accessing data with the portable mobile end according to a corresponding set address;
the user database, including a user related data, a data corresponding to a server, and a data corresponding to a storage device, and recording a service set by a user and an address of a multi-media data of a connecting point, so that when the host is connected to the network, the host automatically sends out the data to facilitate the response of the corresponding server or storage device.

2. The wireless network access multi-media apparatus as recited in claim 1, wherein the I/O port includes a cable network connector, and the cable network connector is a telecommunication transceiver of the Internet or a telecommunication network.

3. The wireless network access multi-media apparatus as recited in claim 1, wherein the I/O port includes a card reader, a message I/O port, a wireless network connector and a cable network connector.

4. The wireless network access multi-media apparatus as recited in claim 1, wherein the central processing unit of the host has an end connected to an output device driven by a hardware driver.

5. The wireless network access multi-media apparatus as recited in claim 4, wherein the output device is a display device.

6. The wireless network access multi-media apparatus as recited in claim 3, wherein the wireless network connector is a wireless telecommunication transceiver of the Internet, or a transceiver of a telephone network.

7. The wireless network access multi-media apparatus as recited in claim 1, wherein the data of the user database is a data related to a user's identity, an address, a name, an identity code, a password, and a channelization code corresponding to a website, an ISP, a network gateway, a server or a hard disk, for facilitating a connection and an authentication with the storage end B when connecting to a network.

8. The wireless network access multi-media apparatus as recited in claim 1, wherein the network is a telecommunication network or the Internet.

9. The wireless network access multi-media apparatus as recited in claim 1, wherein the network connected to the host has another end which is a storage end or a storage device controlled by the server.

10. The wireless network access multi-media apparatus as recited in claim 9, wherein the server is a network server of a general website service provider, a corporation or an individual.

11. The wireless network access multi-media apparatus as recited in claim 9, wherein the storage device is a database controlled by a server or not controlled by the server or a hard disk, a storage space, an optical disk or a storage space of the Internet, a Blog, a network album or a network and a personal multi-media database.

12. The wireless network access multi-media apparatus as recited in claim 1, wherein the intermediary server sets more than one user data.
